(19) United States
(12) Patent Application Publication
(10) Pub. No.: US 2024/0138561 A1
(43) Pub. Date: May 2, 2024

(54) WORKSPACE ORGANIZER

(71) Applicants: Michelle Ann Laaks, Somerset West (ZA); Michael Hollingsworth, Salisbury, NC (US)

(72) Inventors: Michelle Ann Laaks, Somerset West (ZA); Michael Hollingsworth, Salisbury, NC (US)

(21) Appl. No.: 17/974,138

(22) Filed: Oct. 26, 2022

(51) Int. Cl. A47B 21/06; F16B 2/10

(52) U.S. Cl. CPC A47B 21/06; F16B 2/10

(57) ABSTRACT

A workplace organizer is useful for storing, separating, attaching, and moving cords (power supply, USB, HDMI, etc.) to mobile devices. The organizer has the form of a specially formed bulldog clip where one of the jaw members has a cord retention slot formed to extend from the clipping edge, while the other has a plurality of preferably offset slots at that same clipping edge. Each of the jaw members has a curving shape. In order to secure the retained position of the cords in the organizer, an end cap may be detachably fitted over the clipping edge and/or a sliding insert can be received in slots or retention channels on or in at least one of the jaw members. A detachable, segmented handle can be used to easy grasp and move the organizer. The jaw members, end cap, sliding insert, and handle all possess prominent surfaces on which printed indicia can be displayed.

### TECHNICAL FIELD

The present invention relates generally to an assembly for organizing cords and other, similar work place implements and, more specifically, to a bulldog style clip modified to separate, retain, and enable the transport of a plurality of cords (e.g., power supply, HDMI, USB, etc.).

### BACKGROUND

Conventional “docking stations” have been available for decades to connect laptop computers (and, more recently, tablet) to a dedicated desktop or office arrangement. These stations provide a cradle where the device is seated and connected to numerous peripheral devices (e.g., a power supply, one or more video monitors, speakers, microphones, cameras, printers, etc.). The cords required to connect the device to these various peripherals could remain permanently attached or embedded in the docking station, so that the user only needed to lift their device out of the cradle if/when he or she wanted to relocate and transport the computer/device itself.

As more people adopt and rely on mobile devices (e.g., tablets, phones, and smaller, more compact laptops) as their primary or only device for business and personal purposes, docking stations are becoming less relevant. Instead, mobile devices require quick and easy set up in a variety of settings, especially with the growing popularity of coworking, work-from-home, and “hoteled” office arrangements. Thus, there is a need for device users to be able to organize and transport the various cords that are needed to use peripheral devices at disparate locations.

A number of cord organization implements currently exist. U.S. Pat. Nos. 11,056,865 and 10,550,870 disclose cable trays and bushings designed to retain and organize cords. An earlier proposal in U.S. Pat. No. 3,180,597 proposes a similar solution for fastening elongated articles in a conventional construction setting. However, all these implements are installed to fixed objects, such as desks or server trays, thereby making it difficult to reposition and relocate the organizer quickly.

Other proposals recommend using elongated strips with transverse slotted channels for handling a plurality of cords. As above, these solutions tend to take up considerable desk space, and they lack a fashionable aesthetic.

Another proposal is to repurpose seemingly ubiquitous binder clips (similar to the one first disclosed in U.S. Pat. No. 1,865,453). Here, a single cord can, in fact, be captured between the jaws section of the clip or, if the cord and plug are small enough, through the apertures provided on its handles. However, one clip is needed for each cord, which means numerous separate implements are required to organize multiple cords, with considerable effort needed to reposition and/or relocate such arrangements.

In view of the foregoing, a simple, economical, and mobile workplace organizer is needed. Ideally, that organizer should be capable of separating and retaining specific cords in specific positions on a single implement, while the organizer itself should still be easily transported without removing or detaching the cords/plugs.

### SUMMARY

The workplace organizer contemplated herein meets these needs and others. Its modified bulldog-style clip gather cords in one or a minimal number of centralized slots on its bottom facing. The top facing provides multiple, individual slots through which individual cords are separately restrained. A sliding insert can be provided over or next to these individual slots for labeling and/or further restraint. A detachable end cap can be provided so that the cords remain organized even when the organizer is not clipped to a desk or other planar surface. A handle attachment can be connected to allow the user to carry the organizer, while the handle itself can also serve as a means of positioning and stabilizing the clip on a surface whenever the organizer is not clipped in place. Finally, the top and/or bottom jaw members can be formed with an attractive curved appearance that facilitates clipping the organizer to flat planar objects, as well as providing surfaces for branding and advertising, on the top and bottom members, as well as the end cap and/or sliding insert.

Specific reference is made to the appended claims, drawings, and description below, all of which disclose elements of the invention. While specific embodiments are identified, it will be understood that elements from one described aspect may be combined with those from a separately identified aspect. In the same manner, a person of ordinary skill will have the requisite understanding of common processes, components, and methods, and this description is intended to encompass and disclose such common aspects even if they are not expressly identified herein.

### DESCRIPTION OF THE DRAWINGS

Operation of the invention may be better understood by reference to the detailed description taken in connection with the following illustrations. These appended drawings form part of this specification, and any written information in the drawings should be treated as part of this disclosure. In the same manner, the relative positioning and relationship of the components as shown in these drawings, as well as their function, shape, dimensions, and appearance, may all further inform certain aspects of the invention as if fully rewritten herein.

In the drawings:

FIG. 1A is a perspective illustration, FIG. 1B is a side elevation view, and FIG. 1C is a back elevation view, all showing the workplace organizer according to various aspects disclosed herein.

FIG. 2A is a top plan view showing the “inner” facing of the bottom jaw member, and FIG. 2B is a front elevation view, both in isolation and as contemplated in FIG. 1A.

FIG. 3A is a bottom plan view showing “inner” facing of the top jaw member, and FIG. 3B is a front elevation view, both in isolation and as contemplated in FIG. 1A.

FIG. 4 is a perspective illustration of a biasing member in isolation and as contemplated in FIG. 1A.

FIG. 5 is a side elevation view of the connecting pin in isolation and as contemplated in FIG. 1A.

FIG. 6 is a perspective illustration of the workplace organizer of FIG. 1A as it can be installed and used in certain aspects.

FIG. 7A is a perspective illustration of the end cap in isolation and FIG. 7B is a perspective illustration of the workplace organizer of FIG. 1A with the optional end cap coupled thereto.

FIG. 8 is a top plan view of a further embodiment of the workplace organizer, with the end cap set apart from the clipping jaws and with the positioning and handling device attached.

FIGS. 9A and 9B are a combined schematic and plan view illustrating how individual components from the positioning and handling device may be constructed and assembled.

FIG. 10A is a top plan view of an exemplary and optional slide insert that may be used with the workplace organizer of FIG. 1B when appropriately sized retention channels/slots are provided.

FIG. 11A is a side elevation view and FIG. 11B is a top plan view of a further embodiment of the workplace organizer, both providing further indications 12a, 12b for where the slide insert may be provided.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. As such, the following description is presented by way of illustration only and should not limit in any way the various alternatives and modifications that may be made to the illustrated embodiments and still be within the spirit and scope of the invention.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise. Unless expressly stated or clearly indicated from the context herein, references to a badge and/or badge holder may encompass any number of items commonly attached to or held by lanyards, including but not limited to identification and/or key cards, event tickets and/or credentials, key rings, and the like.

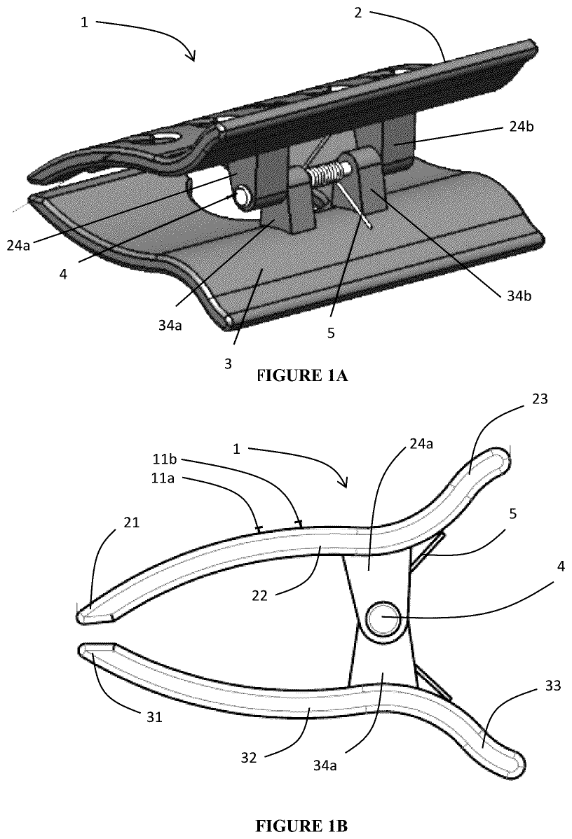

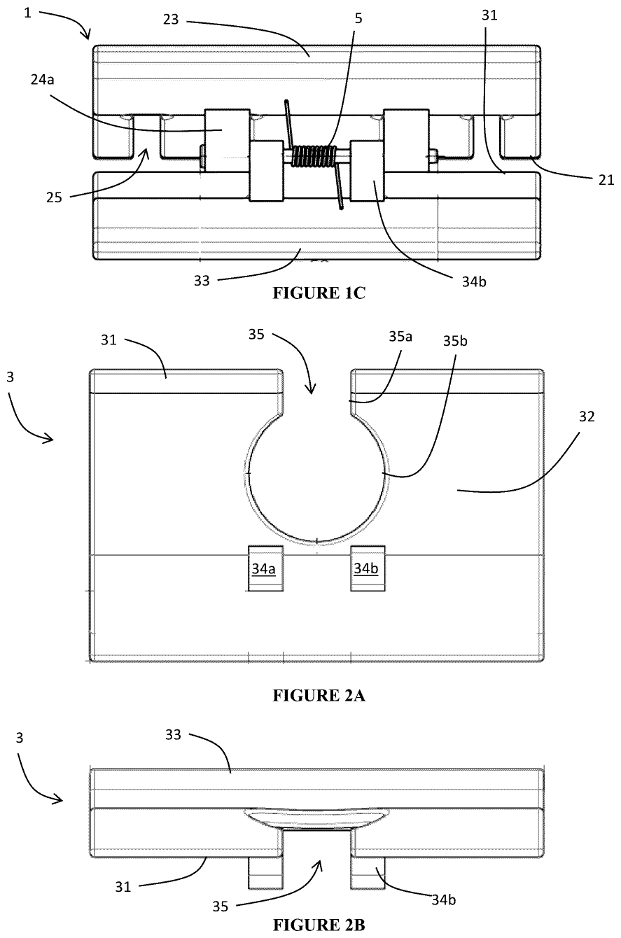

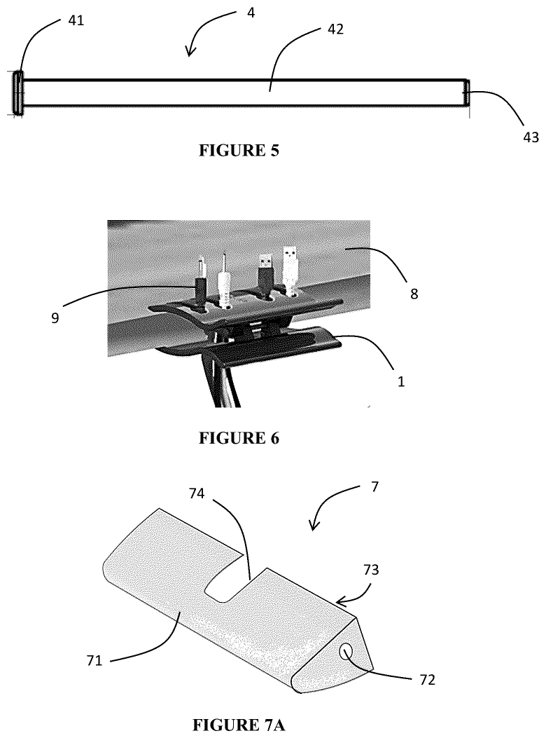

With references to FIGS. 1A through 11B, the workplace organizer 1 is analogous a bulldog clip formed from top jaw member 2 and bottom jaw member 3, which are urged together by biasing member 3. Biasing member 3 may be carried on pivot rod 4, which is received or coupled to attachment flanges 24a, 24b on the top member 2 and attachment flanges 34a, 34b on the bottom member 3.

Each of the jaw member 2, 3 are formed from thin, planar sheets, preferably imparted with a curving and symmetrical shape. In one aspect, the curving shape traces an S-shape (i.e., a “wavy ribbon”), with clipping edges 21, 31 connected to an opposing edge 23, 33 by a sloping or curving midsection 22, 32. Notably, this shape effectively defines a ruled surface, in which a straight line can be drawn from edge to edge along any give transverse point progressing from the clipping edge to the opposing edge of the organizer. In some aspects, this wavy ribbon traces an S-shape, although other curved shapes are possible (parabolic curves, sinusoidal curves, multi-modal and/or “double hump” curves following an M-, W-, or other curving shapes shape, etc.).

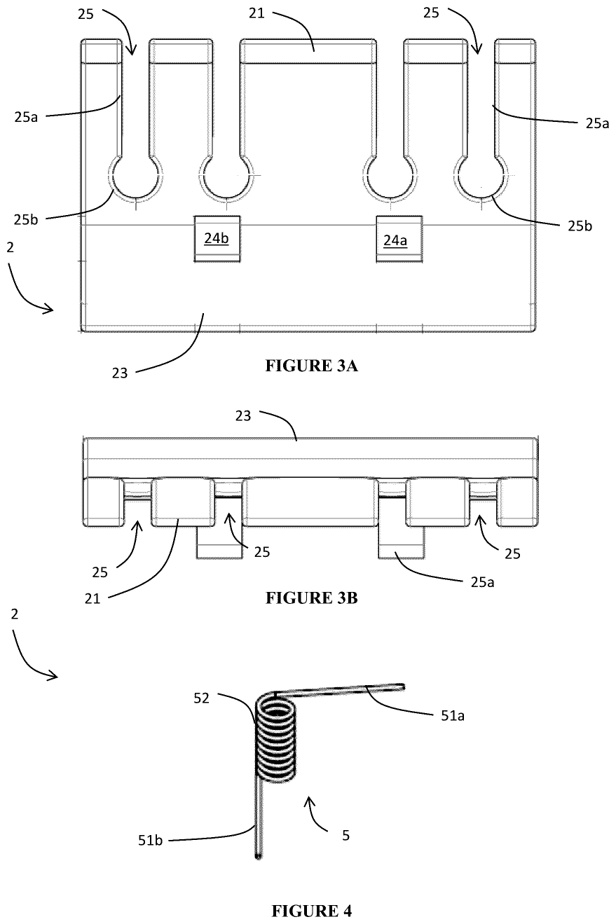

The thin, planar sheets referenced above means that the thickness of the member is significantly smaller (possibly by one or several orders of magnitude) than its length or width. By way of non-limiting example, this means that a thin metal sheet could be stamped into the desired form, although it should be understood that the members 2, 3 can be molded, cast, drawn, forged, or otherwise formed by any appropriate methods, and the materials used to make them could be plastic, metal, or a combination thereof. Further, as used herein, the clipping edges 21, 31 are at one edge of the organizer 1, with the “distal” edge 23, 33 formed across from it so that the edges running between these two points form “transverse” edges (although it will be understood these transverse edges, while shown as straight lines in FIGS. 2A and 3A, could be angled or curved).

At least jaw member 21 (and/or possibly member 31) can be formed with substantially flat sections B which can accommodate logos, branding, or other printed/graphical indicia. The flat sections B are most ideally in the distal, opposing end 23, 33, although it is possible to provide them along or over midsections 22, 32. Sections B can be bounded by or even overlaid around retention channels or slots 25, 35 provided near the clipping edges 21, 31 or on one or both transverse edges, in which case sliding inserts can be introduced to further customize or personalize the organizer 1.

When the organizer 1 is assembled, the edges 21, 31 will be vertically closer together (or touching) in comparison to the corresponding distal edges 23, 33. This arrangement enables the organizer 1 to function like a bulldog clip, while the wavy ribbon shape of each member 2, 3 insures that the spacing in the midsections 22, 32 and distal edges 23, 33 is sufficient to receive, restrain, and accommodate all cords 9 that will enter along the bottom facing at a single point and exit along the top facing at discrete, individual points. Because the slots 25, 35 are arranged along the clipping edge, cords 9 can be manipulated into the slots when the jaws 2, 3 are open but are held/restrained therein when the jaws 2, 3 are closed and/or clipped to a flat surface, such as desktop D. As described in more detail below, end cap 7 and/or sliding insert 12 provide additional means of retaining the cords 9 positioned in the organizer 1, as well as customizing the organizer 1 (e.g., by way of branding, labeling, etc.). The ability to retain and restrain cords 9 enables a user to unplug both ends of all cords and transport the cords and organizer as a single unit, while keeping the individual cord ends accessible and separated.

Another optional feature involves the provision of a sliding insert 12. Insert 12 is a flat planar member made of heavy paper, cardboard or card stock, or a thin sheet of metal or plastic. Insert 12 can provide an additional or alternative means of imparting printed or graphical indicia to the organizer 1, with the insert 12 providing an easy means to alter or update that information. Insert 12 can be received in a channel or between retention flanges 11a, 11b that are positioned on the surface of member(s) 2, 3 in any of the appropriate areas denoted above, including section B. The insert 12 can also be received in a slot formed in the thickness of the jaw member 2, 3, with viewing window(s) provided in one of the surfaces of that member (again, wherever section B is accommodated). In specific aspects, the insert may be received along the distal edge 21, 31 (see FIG. 8) or one or both transverse edges (see FIG. 1B).

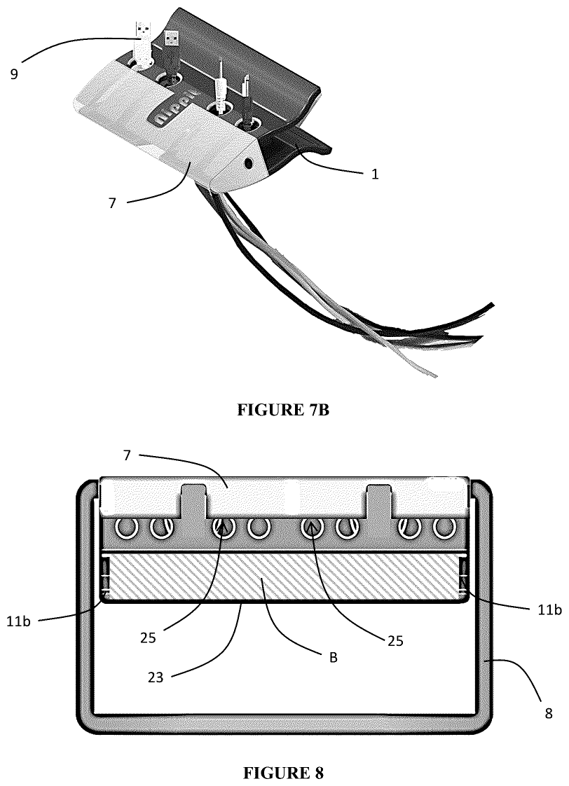

The members will present a distinct polygonal shape, preferably a rectangle or square, when you viewed from the top (as see in FIGS. 2A and 3A). However, other shapes are possible (e.g., curving, oval, semi- or completely circular, etc.), so long as the member possesses the other features and characteristics described herein. In preferred aspects, the clipping edge of each member will follow straight or gently curving line so as to allow for easy insertion and capture of the cords (see FIGS. 6 and 7B).

Top jaw member 2 includes a plurality of individual cord slots 25 arranged along the clipping edge 21. Preferably, the slots are spaced apart at regular intervals, although they can be grouped in two separate clusters close to each transverse edge, so as to present a solid middle section at edge 21, as shown in FIG. 3A. At least two or three, and more preferably between four to eight or ten, slots 25 are provided.

Each slot 25 includes a channel 25a. The opening or width of channel 25a is sized to accommodate the size of standard cords 9 used for mobile devices (not shown). However, this width should be less than the maximum diameter or width of the terminal plug on such cords—in this manner, the cord and plug cannot slide through and fall out of the slot 25 because of the force of gravity. The slots may also terminate in an enlarged circular arc or bulbous section 25b, having a larger diameter/width than channel 25a but still being small enough to provide a seat for the end plug itself (see FIG. 6). Preferably, the slots extend equal to or less than half the distance between clipping edge 21 and distal end 23, so as to terminate in midsection 22.

Bottom jaw member 3 is provided with a cord collection and retention slot 35. Slot 35 will many of the same features as slots 25, in terms of a narrow channel 35a and optionally enlarged circular/bulbous end 35b, although the slot 35 does not need to be sized to restrain and prevent individual cords 9 from “falling out.” Instead, the total surface area of slot 35 should be large enough to accommodate the expected cumulative surface area of the total number of individual cord slots (e.g., if a standard sized cord occupies 5 mm² along its diameter and the top jaw provides four slots, the retention slot must have at least 20 mm² of surface area). More preferably, the enlarged area 35b is sized to accommodate the total area required by the total expected cords.

The individual organizing slots on the top member can be vertically offset from the retention slot(s) on the bottom member. In this context, vertically offset means cords must be bent as the pass through the retention slot and the individual holding slot. This arrangement insures that cords restrained by the organizer cannot fall directly through organizer. Additionally, the size of the channel and the circular arc in the individual slots can be selected to receive the diameter of standard sized cords, but the circular arc is has a larger diameter than the width of the channel. Ideally, that circular arc will be sized to allow the terminal plug portion to be seated on the periphery of the circular arc but without having the plug portion pass through it.

At least one and preferably two or more attachment flanges 24a, 24b extend away from the midsection 22, preferably in orthogonal direction to their point of attachment with the member 2 along the inner or bottom facing. As noted below, corresponding flange(s) 34a, 34b are formed on the inner or top of member 3, again preferably at the midsection 32. All of the flanges will include an aperture, slot, or other conventional means to receive, couple, or accommodate pivot pin 4. These flanges should be spaced apart along a transverse line (i.e., from transverse edge to transverse edge) of the organizer 1.

A pivot pin 4 is coupled to the flanges 24, 34, and a biasing member 5 is fixed to the pin 4 (and/or possibly the inner facings of members 2, 3) to impart the bulldog clip function referenced above. In a preferred arrangement, pin 4 includes an enlarge head 41 and an elongated cylindrical section 42. Head 41 and distal end 43 can be provided with apertures or other attachment means to accommodate handle 8 (although, as noted below, handle 8 can also be configured to couple to the end cap 7).

In FIG. 4, biasing member 5 preferably takes the form of a torsion spring. Such springs have lever arms 51a, 51b which generate spring force that is exerted against the inner facings of the members 2, 3. Arms 51a, 51b could also be configured to snap-fit or otherwise couple to the members 2, 3. A central coiled section 52 defines a hollow center that is sized to receive the elongated section 42 of pin 4. Thus, by aligning the spring 5 between the flanges 24, 34 when the clip is assembled, the biasing member 5 can be carried on the pin 4 while remaining properly positioned to exert the required biasing force (owing to the spring's positioning between the flanges).

End cap 7 has a wedge-like shape that will conform to the clipping edges 21, 31 when the organizer 1 is not clipped to a surface D. That is, end cap 7 acts as a removable cover that encloses the channels 25a, 35a. Thus, the end cap includes an enlarged open end 73 and a closed end 71. The cap 7 may include apertures or coupling features 72 on its transverse sides for attaching handle 8. An optional cutout or window 74 provides visibility for indicia that might be printed on one or both of the jaws 2, 3. Branding or printed indica can also be disposed on the visible surfaces of end cap 7 itself and/or it may be possible to provide retention flanges so that a sliding insert or card could be affixed to the end cap 7 for all of the purposes noted herein.

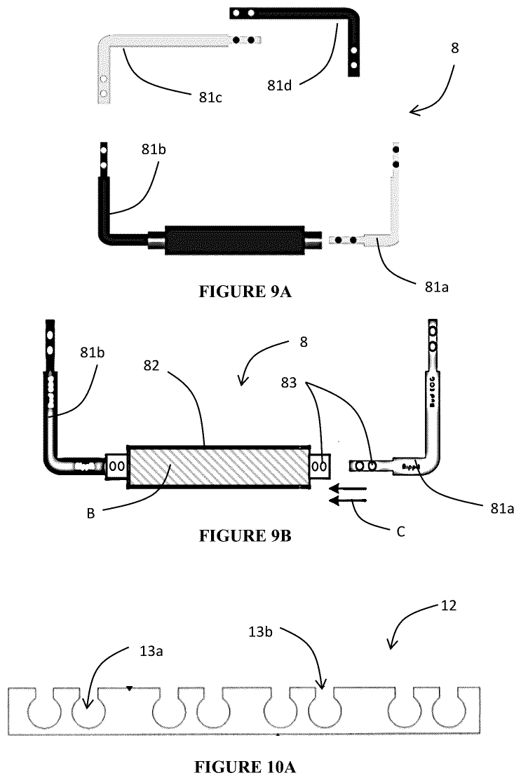

Handle 8 is another optional accessory to simplify moving and transporting the organizer, as shown in FIG. 8. The handle 8 may have a block C style shape, or it can be formed in segments that create a continuous O shape. When the later is employed (and with reference to FIGS. 9A and 9B), a plurality of coupling segments 81a, 81b, 81c, 81d may be provided. When four segments are used, they may be provided as identically shaped L-sections, with one segment having an optional grip 82. Alternatively, the segments can vary in number and/or have comparative varying shapes (e.g., two L-shapes and one C-shape, two J-shapes, etc.). Each segment 81a, 81b is fitted together as indicated by arrows C. The ends of these segments can be snap-fitted or provided with coupling features 83, such as spring pins and apertures, bayonet-style slots and grooves, etc., so as to allow for the assembly and disassembly of the handle 8. Alternatively, handle 8 may have a unitary C-shape, with the spring force exerted by each end being sufficient to seat and couple the handle 8 in and to the apertures 72 and/or apertures in the pin 4.

Handle 8 can also be designed to attach at an offset angle (relative to the plane of symmetry between the top member 2 and bottom member 3) so as to allow the handle 8 to serve as a stabilizing stand. In this regard, the attachment apertures used to couple the handle 8 to the organizer 1 can have keys, notches, or distinctive shapes to insure the handle 8 is attached and remains in the desired angle. In some aspects, the handle 8 also presents an opportunity to affix branding or printed/graphical indicia in section B (although, as above, this section need not be completely flat).

FIG. 10A shows an exemplary sliding insert 12. As noted above, this insert may be a simple card of a thin rectangular shape that allows the user to write on it (e.g., to label slots proximate to it, to indicate ownership, or to convey other personalized information). Insert 12 could also be provided with slots, channels, or apertures 13a, 13b to allow cords and plugs with varying and/or different sizes to pass through. By way of example rather than limitation, slot/apertures 13a can be larger or smaller than those provided at 13b (and similarly across the entirety of insert 12). Insert 12 also allows for branding, labeling, and other informational purposes, although this information may not be visible when the insert 12 is installed on the organizer 1. It will also be understood that FIG. 10A is merely exemplary, and any number of slots/apertures 13a, 13b can be provided on or in the main thin rectangular member of insert 12.

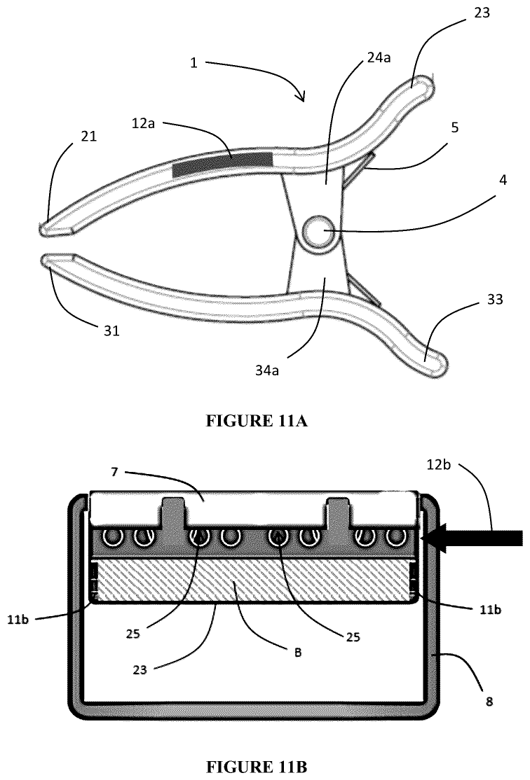

FIGS. 11A and 11B provide an indication of where the sliding insert 12 can be introduced into the organizer 1. It will be appreciated that different sized holes and/or slots can be provided on insert 12 so as to allow for the retention/organization of different sized cords and plugs. Similarly, a plurality of inserts 12 can be included with the organizer to expand its functionality.

Generally speaking, when the organizer clip is approximately 22 cm in transverse width (i.e., from edge to edge), the body should be about 6 cm deep from the clipping edge to its opposing edge (with the optional handle being about double that depth, i.e., 12 cm). This arrangement leaves about 40 cm 2 of visible area for branding/printed indicia near the opposing edges 23, 33 on the jaw members 2, 3. Additional branding area can be provided on the end cap 7 and/or the handle 8. Smaller or miniaturized versions are also possible, although the transverse width should be sufficient to accommodate at least one or two distinct slots. Some versions might have up to eight, ten, or twelve slots.

The foregoing provides the details of various aspects of the invention. In a preferred aspect, the invention may comprise a first member formed with a polygonal shape that includes a curving surface. One, two, or some other number of attachment flanges extend down from the curving surface, while anywhere from two to ten or more slots extend from the clipping edge of the first member. A second member has a complimentary or identical polygonal shape and curving surface, again with one, two, or some other number of attachment flanges extending up from the surface toward the first member, while one or two retention slots extend from the clipping edge of the second member. A pivot pin is received by features on the attachment flanges of each member in order to couple the first and second member together, while a biasing member (such as a torsion spring) is positioned to urge the clipping edges of each member toward one another. Any one or combination of the following, additional features constitute other aspects of the invention:
wherein each of the plurality of slots have an enlarged opening offset from the clipping edge by a narrow channel;
wherein the retention slot has an enlarged opening offset from the clipping edge by a narrow channel;
wherein the enlarged openings define a circular arc;
wherein the first member includes between three and ten slots;
wherein the second member includes two equally spaced apart retention slots;
wherein each the retention slot is vertically offset from the plurality of slots;
wherein the plurality of slots have varying sizes configured to receive cords or plugs of varying dimensions;
wherein the first member and the second member are only in physical contact at the attachment flanges;
wherein the complimentary polygonal shape is identical to the polygonal shape;
wherein the complimentary curving surface is symmetrical to the curving surface;
wherein the polygonal shape is selected from a rectangle and a square;
wherein the curving surface is an S-shape with at least one flattened portion;
wherein two attachment flanges are provided on each of the first member and the second member;
further comprising an end cap detachably coupled over the clipping edges of so as to block the plurality of slots and the retention slot when the end cap is coupled to the workplace organizer;
further comprising a positioning and handling device detachably coupled to the workplace organizer;
wherein the positioning and handling device has a C-shape with each end of the C-shape configured to couple to opposing apertures provided in the end cap;
wherein the positioning and handling device is assembled from a plurality of segments; and
further comprising a slide insert received by retention features provided on a facing of the first member.

In some embodiments, snap fitting. fasteners, adhesives, and the like may be employed to insure components remain coupled or attached. These components may be made of any appropriate material or combination of materials. In some instances, metals (including but not limited to steel, aluminum, and the like) provide both durability and aesthetics. Polymeric materials and plastics allow for low cost materials and manufacturing advantages (e.g., molding techniques) that may not be feasible with metals.

The foregoing embodiments produce a workspace organizer that is intuitive, easy to position, and cost effective to manufacture. While discrete aspects may be characterized or depicted herein, it will be understood that certain features from one may be applied to the other embodiments.

Although the present embodiments have been illustrated in the accompanying drawings and described in the foregoing detailed description, it is to be understood that the invention is not to be limited to just the embodiments disclosed, and numerous rearrangements, modifications and substitutions are also contemplated. The exemplary embodiment has been described with reference to the preferred embodiments, but further modifications and alterations encompass the preceding detailed description. These modifications and alterations also fall within the scope of the appended claims or the equivalents thereof

What is claimed is:

1. A workspace organizer comprising:
a first member having a polygonal shape formed along a curving surface, at least one attachment flange extending away from the curving surface, and a plurality of slots extending from a clipping edge on the polygonal shape;
a second member having a complimentary polygonal shape along with a complimentary curving surface (both relative to the first member), at least one attachment flange extending away from the complimentary curving surface and a retention slot extending from a clipping edge on the complimentary polygonal shape;
a pivot pin coupled to each of the at least one attachment flange of the first member and the at least one attachment flange of the second member; and
a biasing member carried on or adjacent to the pivot rod and positioned to urge the clipping edge of the first member toward the clipping edge of the second member.

2. The organizer of claim 1 wherein the biasing member is a torsion spring.

3. The organizer of claim 1 wherein each of the plurality of slots have an enlarged opening offset from the clipping edge by a narrow channel.

4. The organizer of claim 1 wherein the retention slot has an enlarged opening offset from the clipping edge by a narrow channel.

5. The organizer of claim 3 wherein the enlarged openings define a circular arc.

6. The organizer of claim 1 wherein the first member includes between three and ten slots.

7. The organizer of claim 6 wherein the second member includes two equally spaced apart retention slots.

8. The organizer of claim 1 wherein each the retention slot is vertically offset from the plurality of slots.

9. The organizer of claim 1 wherein the plurality of slots have varying sizes configured to receive cords or plugs of varying dimensions.

10. The organizer of claim 1 wherein the first member and the second member are only in physical contact at the attachment flanges of said members.

11. The organizer of claim 1 wherein the complimentary polygonal shape is identical to the polygonal shape.

12. The organizer of claim 1 wherein the complimentary curving surface is symmetrical to the curving surface.

13. The organizer of claim 1 wherein the polygonal shape is selected from a rectangle and a square.

14. The organizer of claim 1 wherein the curving surface is an S-shape.

15. The organizer of claim 1 wherein two attachment flanges are provided on each of the first member and the second member.

16. The organizer of claim 1 further comprising an end cap detachably coupled over the clipping edges of so as to block the plurality of slots and the retention slot when the end cap is coupled to the workplace organizer.

17. The organizer of claim 1 further comprising a handle detachably coupled to the workplace organizer.

18. The organizer of claim 17 wherein the handle has a C-shape with each end of the C-shape configured to couple to opposing apertures provided in the end cap.

19. The organizer of claim 17 wherein the handle is assembled from a plurality of segments.

20. The organizer of claim 1 further comprising a slide insert received by retention features provided on a facing of the first member.
